(19) United States
(12) Patent Application Publication
(10) Pub. No.: US 2005/0020337 A1
(43) Pub. Date: Jan. 27, 2005

(54) Trading or playing card system

(76) Inventor: Gregory C Simmons, Brighton (GB)

Correspondence Address: PATENT LAW GROUP LLP, 2635 NORTH FIRST STREET, SUITE 223, SAN JOSE, CA, 95134, US

(21) Appl. No.: 10/487,294

(22) PCT Filed: Aug. 9, 2002
(86) PCT No.: PCT/GB02/03682

(30) Foreign Application Priority Data
Aug. 22, 2001 (GB) 0120439.5

(51) Int. Cl. G06F 17/00; G06F 19/00

(52) U.S. Cl. 463/11

(57) ABSTRACT

One aspect provides a trading or playing card system including a plurality of cards or other media having specified identities or characteristics, the identities or characteristics providing an embedded value determinable by validation by a third party. Another aspect provides a trading or playing card system including a plurality of cards having specified identities or characteristics, and a remote site providing interactive applications controlled by the identities or characteristics of the cards. The interactive applications may include interactive games, for which a card may include predetermined characteristics affecting the degree of control of the game. The remote site may be accessed by the Internet or television or any other suitable medium. The system can provide for the display of advertising linked to the card or cards identified by the system. Another aspect provides a trading or playing card system including on at least some of a plurality of trading or playing cards a code providing a gaming advantage usable in an electronic game to adjust electronically the playing characteristics of the game to the advantage of the user. The advantage could in effect be a “cheat code”.

The present invention relates to barcode applications including for a trading or playing card system and to an interactive medium using such codes.

Trading cards have been known for many years. Examples are cards based on a sport such a football, basketball and, more recently, character cards such a Pokemon(™). On the whole, these cards are simply collectibles although more recently they can be used in the playing of a specified game.

The present invention seeks to provide an improved trading card and interactive medium using such cards, for example to allow the playing of an interactive game. It also seeks to provide new applications for barcode systems.

According to an aspect of the present invention, there is provided a trading or playing card system including a plurality of cards or other media having specified identities or characteristics, said identities or characteristics providing an embedded value determinable by validation by a third party.

The preferred embodiments allow the use of, for example, barcodes in many different ways. One specific area in which they are able to operate is in effect to add value to the barcode itself and not just provide functionality from the use of the barcodes.

According to another aspect of the present invention, there is provided a trading or playing card system including a plurality of cards or other media having specified identities or characteristics, a remote site providing interactive applications controlled by the identities or characteristics of the cards or other media.

The interactive applications may include interactive games, for which a card may include predetermined characteristics affecting the degree of control of the game.

Advantageously, the cards are provided with machine readable codes indicative of said identities or characteristics.

The remote site may be accessed by the Internet or television or any other suitable medium.

The system preferably provides for the display of advertising linked to the card or cards identified by the system.

According to another aspect of the present invention, there is provided a trading or playing card system including on at least some of a plurality of trading or playing cards or other media a code providing a gaming advantage usable in an electronic game to adjust electronically the playing characteristics of the game to the advantage of the user.

The preferred embodiment is directed to the games console market which includes systems such as the Xbox(™), Playstation 2(™) and Game Cube(™). Within this market there is a high demand for “cheat codes”, these are codes that allow the player to cheat various sections of the game. This could be in the form of unlimited life, unlimited ammunition or even access to hidden levels. One more subtle function of cheat codes is to prolong interest in the games, increasing the length of their popularity and extending the commercial life.

Such “cheat codes” are currently inputted manually, a process which is very time consuming and frustrating. This process could be made much easier if the user could scan a cheat barcode.

Advantageously, the cards or other media have specified identities or characteristics, said identities or characteristics providing an embedded value determinable by validation by a third party. The preferred embodiments allow the use of, for example, barcodes in many different ways. One specific area in which they are able to operate is in effect to add value to the barcode itself and not just provide functionality from the use of the barcodes.

According to another aspect of the present invention, there is provided computer or television based trading or playing card hosting system including a host site providing card validation means, one or more databases providing data relating to cards and data transfer means operable to transfer data to the host site relating to a card and to transfer data back to a user site.

The data transfer means preferably provides for transfer of data relating to card identity and may be a barcode. Advantageously, the data transfer means is designed to transfer data automatically upon the receipt of a trading card from a user.

The system preferably provides for the display of advertising related to a particular card or card type.

Advantageously, the system provides for the awarding of prizes for individual cards, which awarding is carried out by the host site. In this embodiment, there is preferably provided the facility for prizes to be collected from a retail outlet, with means for the retail outlet to validate a card by reference to the host site.

According to another aspect of the present invention, there is provided a computer or television user interface including an underlying menu reproducible on a display and a plurality of icons reproducible on the menu, wherein the icons are changeable to provide for changing functions, wherein a change in the icons displayed does not cause a change in the appearance of the underlying menu.

According to another aspect of the present invention, there is provided a computer or television user interface including a menu reproducible on a display and a user site and a menu reproducible by a remote host site, wherein the user site menu and the host site menu have substantially identical appearances. In the preferred embodiment, each menu is an underlying menu over which a plurality of icons are reproducible, the icons being changeable to provide for changing functions, wherein a change in the icons displayed does not cause a change in the appearance of the underlying menu.

The preferred system uses the existing concepts of collectable trading cards and barcode technology together to create an interactive experience. The experience can include an interactive game played by different people located remotely from one another, such as thorough the Internet or interactive television. It can also provide additional information relating to the card, stored remotely, which information may include winnings details and the like.

The system can also provide on-line shopping and function over both the Internet and satellite/cable television networks. For this purpose, the preferred system includes provision to scan commercial barcodes present on almost every retail product, which data can then be used online to facilitate e-commerce at the consumer level. The idea is to bring the checkout scanner in the supermarket into the home.

By placing a barcode on the face of a trading card, the card is provided with a digital identity such that when it is placed in the appropriate reader, the card then becomes a key to activate the host system.

The preferred system comprises a flexible, multifunctional piece of hardware supported by a software package which operates interactively over the Internet and satellite television networks.

The applicant knows of no other interactive entertainment device of such a type.

The preferred embodiment provides a multifunctional tool that offers various different facilities which can be applied on a business-to-business and business-to-consumer basis. It utilises a purpose built piece of hardware coupled with a software package to function. The hardware itself is much like a miniature barcode scanner, which is able to function for a number of different uses due to the flexibility of the accompanying software package.

On a business-to-consumer level, this embodiment can provide consumers with entertainment over the Internet and interactive television networks, interactive shopping facilities and facilitate product manufacturer accessibility.

One described embodiment is primarily targeted at a juvenile age group and utilises collectable trading cards which are provided with barcodes on the cards' face. The barcode allows identification of the specific card for information retrieval and for interactive uses.

The addition of the barcode element allows the user, via the barcode reader, to be taken directly to a target website or television station where he/she is able to interact with the virtual environment that they have entered. This can allow users to compete head to head in sanctioned events with the actual card(s) that they posses. This can bring a whole new element to the world of card gaming that is easily introduced into a world that embraces the Internet or interactive television.

Advantageously, the system gives the user a television-style operation. That is, just plug the card into the card reader and turn the system on. With this in mind the preferred system allows the user to be visually entertained immediately, in high resolution, without having to click on anything or be subjected to a myriad of “pop-ups”, bringing a whole new aspect to a trading card.

A practical embodiment provides real-time graphics, such as Shockwave(™) and Flash Media(™), to reward the user with exclusive footage, limited edition screen savers, membership to restricted areas, the use of chat rooms and the like. During such a phase that the user is presented with advertising ideally related to the user's card. To supplement this, the system allows a user to register the card and his/her personal information.

The preferred embodiment provides a barcode reader which can also be used for interactive shopping. This feature brings the retail outlet directly into the home, which would see the consumer scanning the item instead of a cashier. By scanning the individual barcodes on retail products, the consumer can easily purchase them via the Internet or over interactive television without the problem of having to scroll through menus or type in code numbers, thus facilitating the use of virtual shops.

All a user needs to do in the preferred embodiment is scan an item with the reader, connect it to their computer or television receiver, download his/her shopping list and transmit his/her billing information, all from the comfort of home. A website provided by the system would be a cross-roads for this type of on-line shopping.

The preferred system can offer various business-to-business services. First and foremost is a totally new interactive advertising and promotional tool that ensures patronage. As all of the facilities can only be utilised, in the preferred embodiment, over the Internet and television networks, advertisers have a captive audience.

As the barcode reader doubles up as a general reader, it offers businesses a new point of sale. In principle it is that same method by which a supermarket records inventory and controls re-ordering. By using the barcode present on all retail products, the system can improve stock control, purchasing and production levels. This will occur by the mere fact that a consumer's shopping list can be processed as part of a store's own ordering because the items are not being purchased as stock to go on a shelf but with a sale secured order directly from the consumer.

The barcode reader can also give businesses utilising barcode technology improved Internet visibility. If a consumer scans an individual item, he/she will be able to access the relevant manufacturer's website as the preferred system's software will recognise the scanned commercial product barcode. This type of facility will assist in customer relations as at the moment the Internet represents an ever-growing beast in which millions of consumers, manufacturers and the like all vie for visibility. More specifically, barcodes are product unique so the correct retailer or manufacturer can be found, rather than other retailers/manufacturers unconnected with that product but sharing the same or a similar company name.

In addition to all of this, the system preferably also includes means for accurately collecting demographic information. For example, the system can be set up such that in order to obtain full facilities offered by the system, a user has to enter specific information regarding him/herself, which will not only be used for marketing but also provided to manufacturers, marketing companies and the like for their use. This information can then be used to develop new products, improve marketing methods, define real consumer requirements and the like. It will be able to define the businesses requirements for the consumer base of the future.

The invention also extends to cards used for other purposes than trading and which may have downloadable data associated therewith and/or which are related to a competition or promotion.

Embodiments of the present invention are described below, by way of example only, with reference to the accompanying drawings, in which:

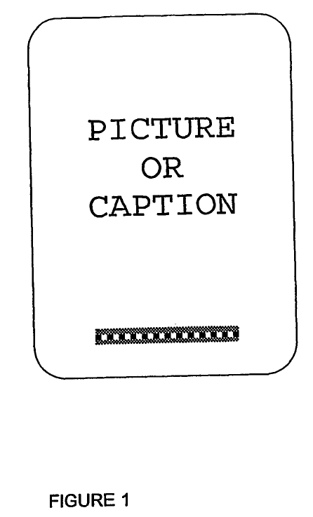

FIG. 1 is a schematic view of an embodiment of trading card;

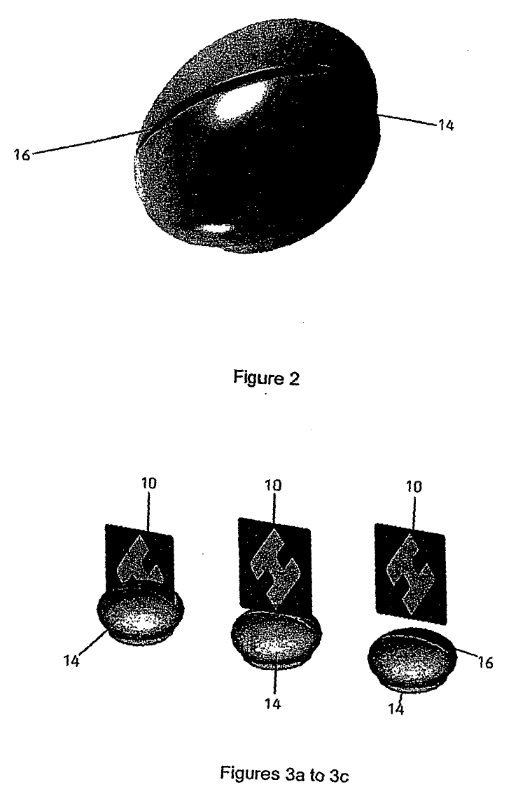

FIG. 2 is a schematic view of an embodiment of card reader;

FIGS. 3a to 3c show insertion of the card of FIG. 1 into the reader of FIG. 2;

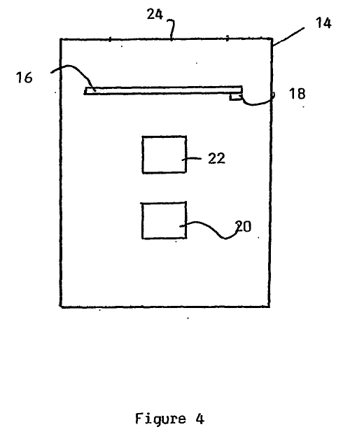

FIG. 4 is a schematic diagram showing the principal components of the reader of FIG. 2;

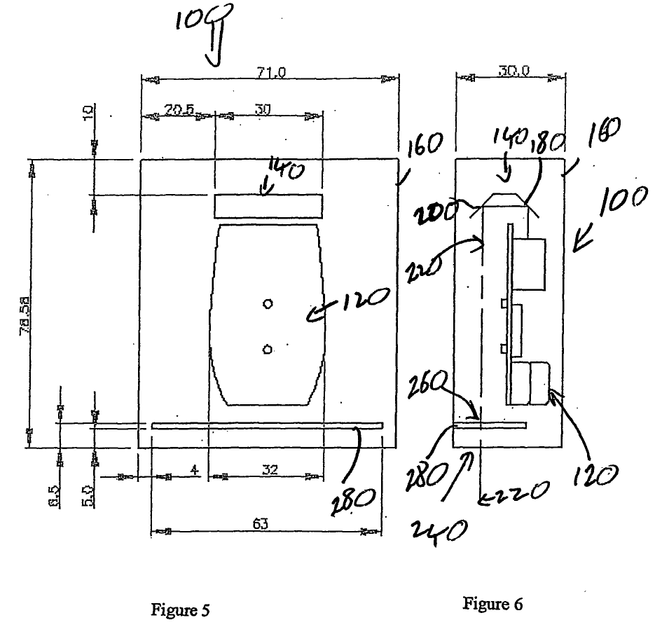

FIGS. 5 and 6 are schematic views of a preferred embodiment of card reader;

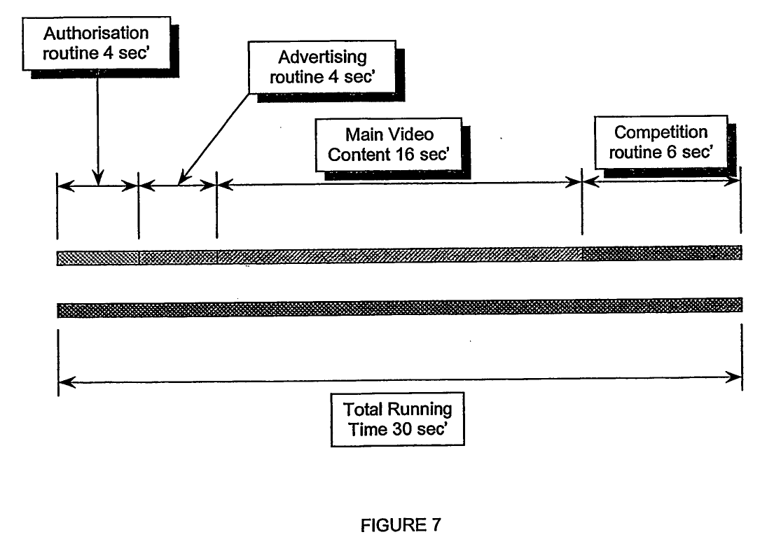

FIG. 7 is a timing diagram of a connection routine to a host server;

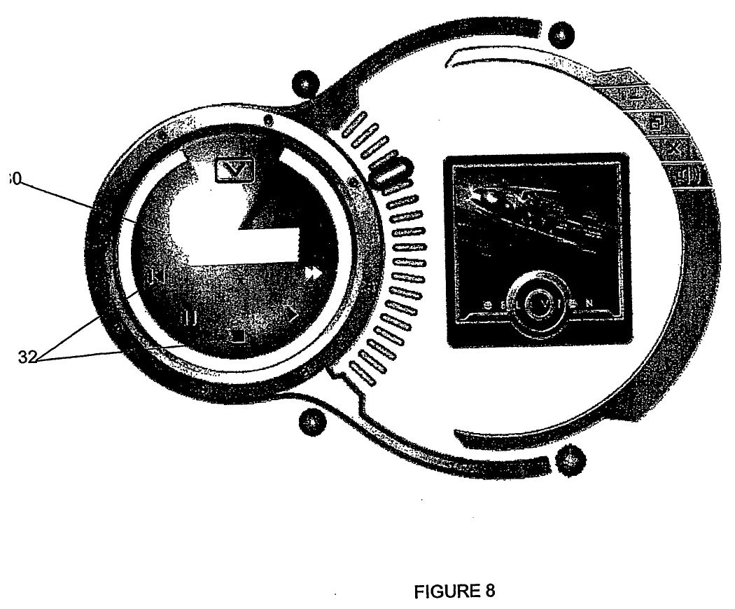

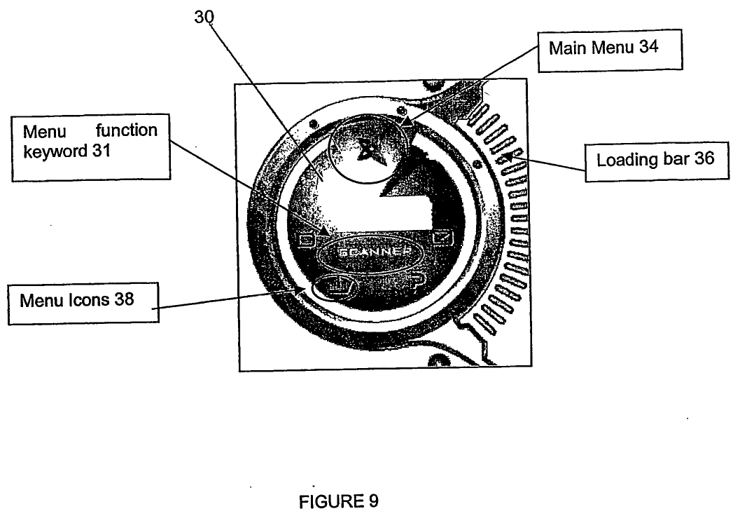

FIGS. 8 and 9 are front elevational views of the preferred embodiment of user interface in a first configuration;

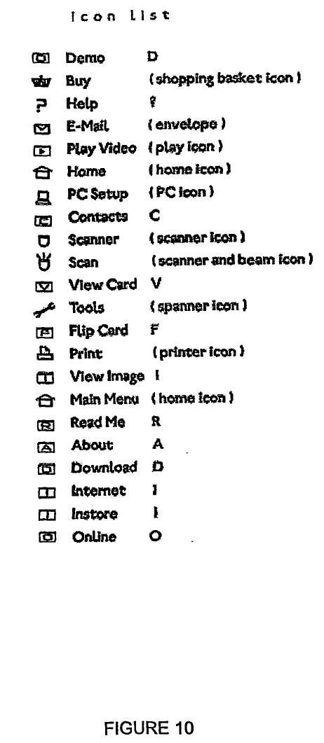

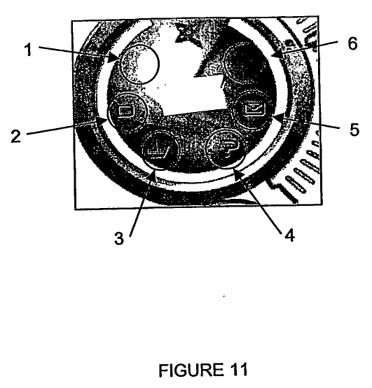

FIG. 10 is a list of the preferred icons for the user interface of FIGS. 8 and 9;

FIG. 11 shows the icon positions of the user interface of FIGS. 8 and 9;

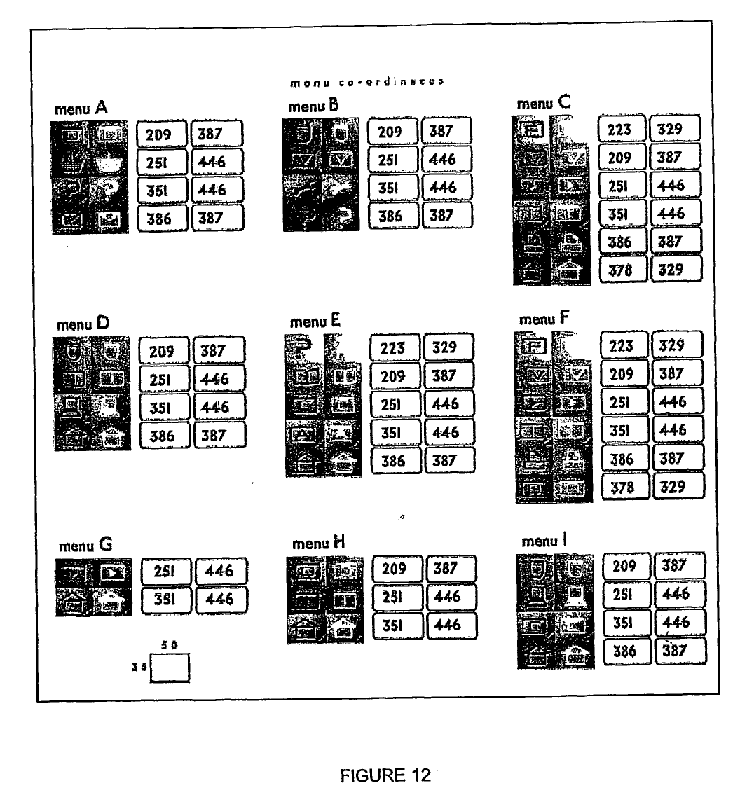

FIG. 12 shows the icons for the user interface of FIGS. 8 and 9 with reference to a bit map;

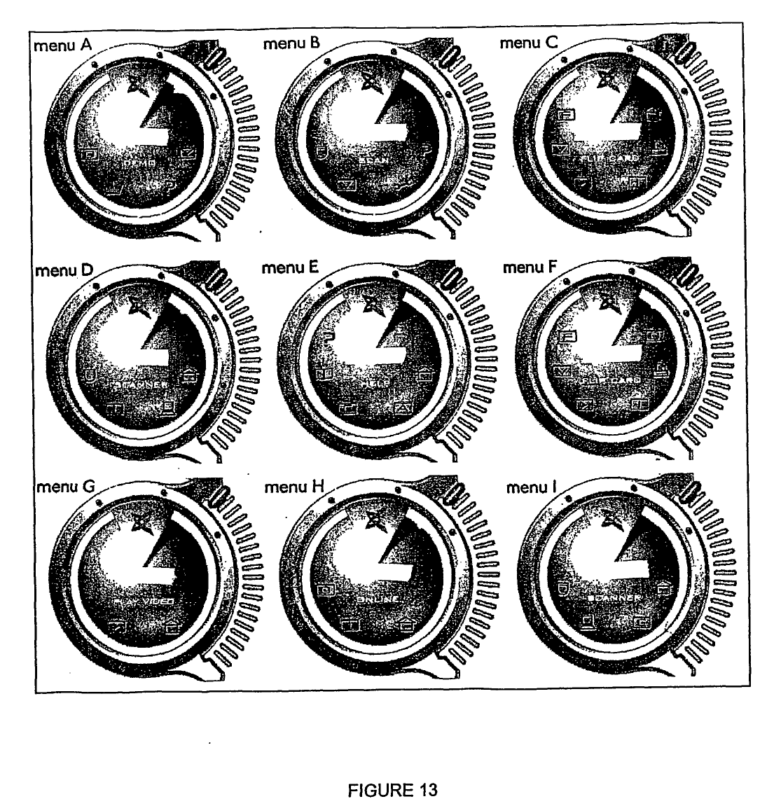

FIG. 13 shows all the menu layouts for the preferred user interface;

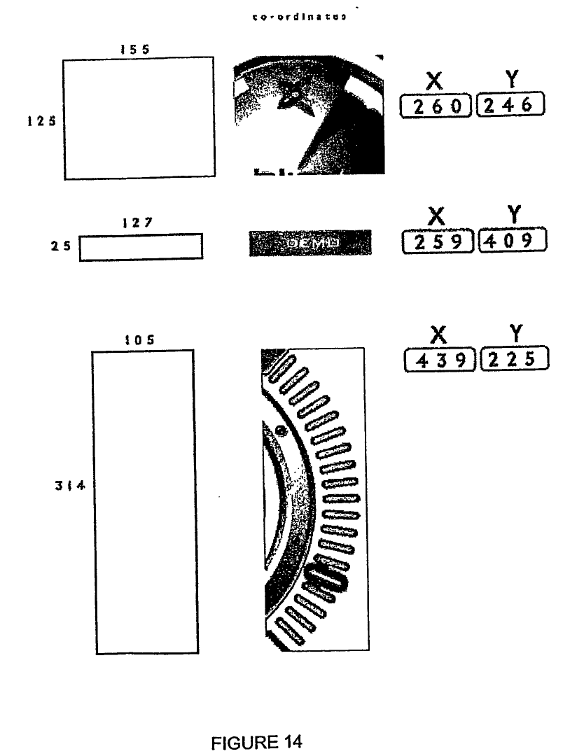

FIG. 14 shows the co-ordinates for various parts of the user interface;

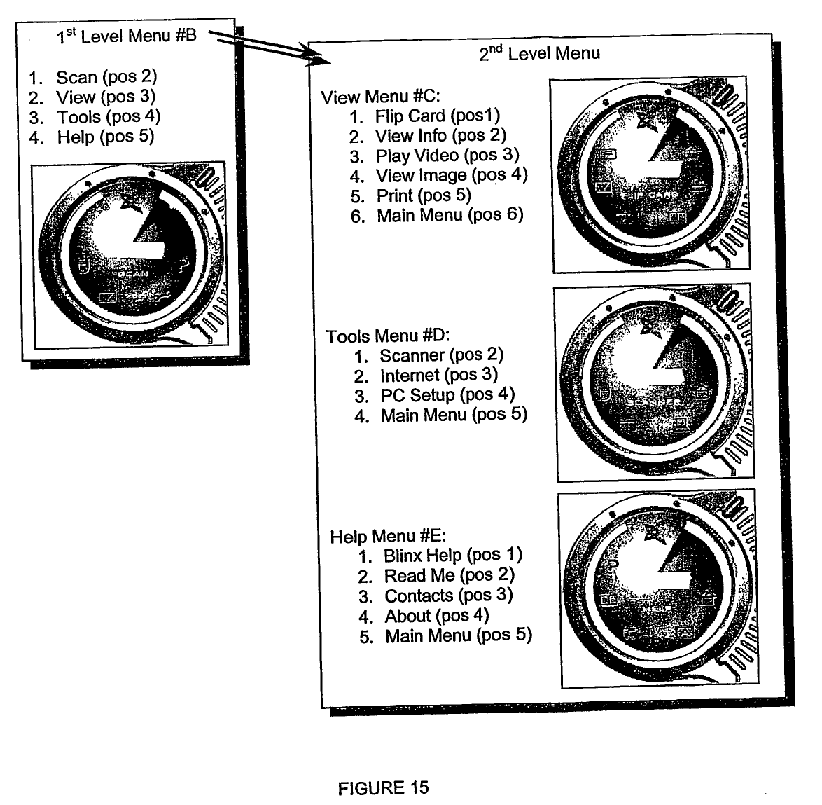

FIG. 15 shows an example of progression through the menu layouts;

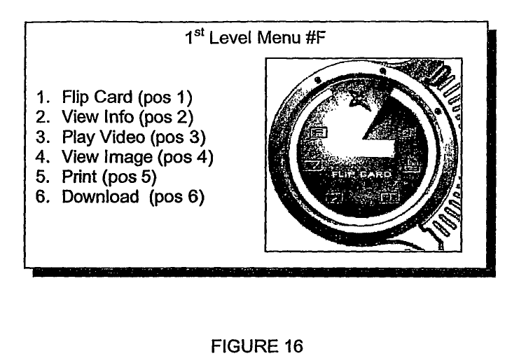

FIG. 16 shows the preferred first level menu layout seen by a user;

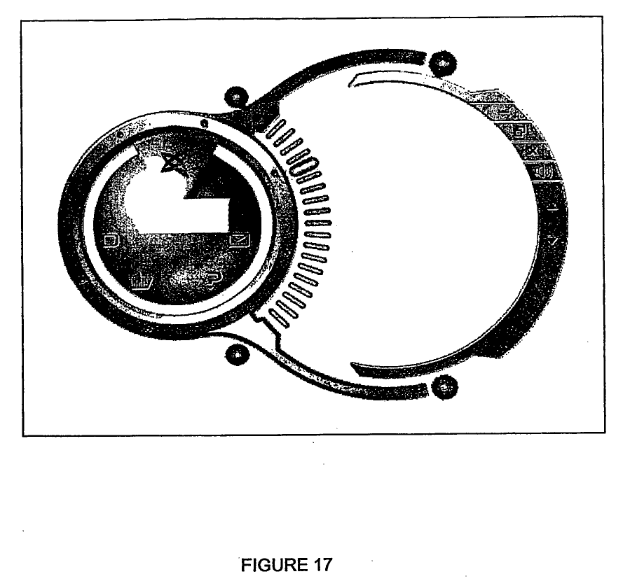

FIG. 17 shows the preferred main menu for the host site;

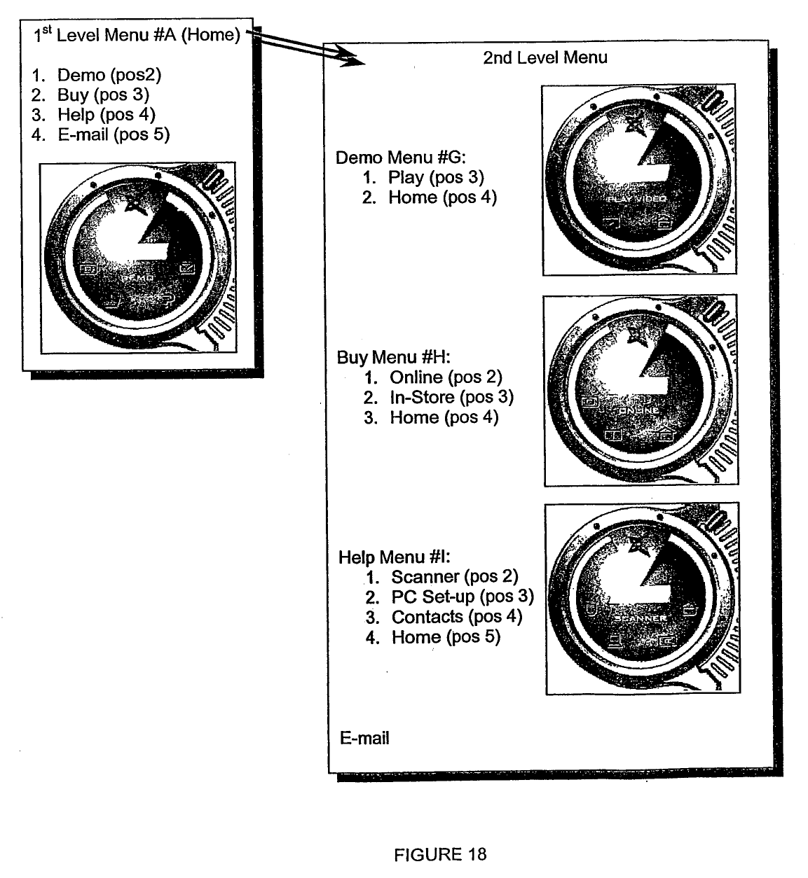

FIG. 18 shows the preferred main menu and sub-directories for the host site; and

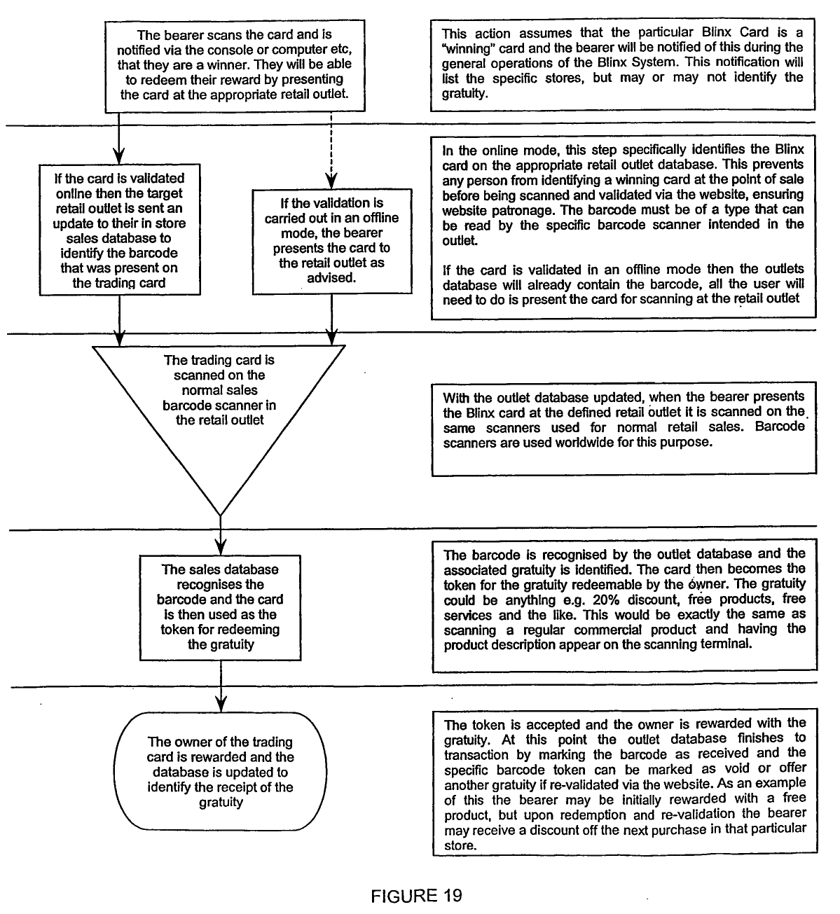

FIG. 19 shows an embodiment of routine for performing the preferred embodiment of system.

One embodiment of system provides one or more collections of trading cards which can be purchased by the public. The trading cards provide access to a host site, such as an Internet server, through a user's personal computer or television set. The host site provides numerous features, such as:
data relating to a card which can be downloaded into the user's computer or television set for reference,
interactive functions such as the playing of a game with other users located elsewhere but also connected to the host site,
the validation of the card for competitions, shop/store discounts and the like,
targeted advertising based upon the card type (such as for a child's trading card
advertising could be of toys relating to the card subject; for a juvenile's trading card of merchandise such as football clothing relating to the card subject).

This embodiment of system also provides for a link to shops/stores in a form which allows validation of a card at the shop/store for collection of a prize, validation of a discount obtainable with a card. For this purpose, a shop/store would be provided with the facility to validate a card by access to the host site, upon which the site would advise the shop/store of the entitlement of the card. For this purpose, the shop/store could be provided with a specific card reader and display device or could use a shop/store's existing barcode reading system.

The host site is preferably provided with a plurality of profiles for a plurality card types. Each profile includes a database topic, interactive functions for the card type, targeted advertising, competitions and promotions relating to the card type and so on. The database includes downloadable information, authentication procedures and data and so on. For a plurality of card types, the database will cover several topics, such as football, motor racing, a fictitious characters. The site is preferably also provided with the facility to create a new profile for new sets of trading cards which may be launched. For this purpose, the system is designed to determine the card type and to provide access to the associated profile and the part of the database and interactive functions relating to that card type.

The profile is an active document, to enable the host to update information that could include season results, technical changes and any other general information. It assists in the overall management of the site, enabling the host to easily incorporate modifications to the output viewed by the user.

The total output information for each topic could include the following:
JPG Images of both sides of the card
Video or Flash Presentation
High Quality wallpaper image
Factual information

An embodiment of card 10 shown in FIG. 1 is intended to be similar in shape and structure to conventional trading cards, although has the addition of a barcode 12 thereon. The barcode is preferably of EAN or 128 type, which identifies the card itself via an encrypted serial number. This barcode 12 can be either visible or invisible. For technical and operational reasons it does not matter if the barcode is invisible, but this will significantly affect the overall costs of the reader. Visibility of the barcode 12 does not affect the security of the card, as will become apparent from the description of the security features given below. A visible bar code can be used for product identification in the marketplace.

However, an invisible barcode can provide aesthetic advantages as it need not detract from the card's other visual elements.

Referring now to FIGS. 2, 3a to 3c and 4, an embodiment of card reader 14 is shown. The reader 14 is provided with a slot 16 of dimensions suitable for receiving a card 10. As can be seen in FIG. 4, the reader 14 includes micro-switch 18 which is triggered on insertion of a card 10 into slot 16. An internal battery 20 and to a barcode reading engine 22.

Power is preferably only supplied when a card 10 is inserted into the reader 14 and triggers the micro-switch 18 to connect the battery supply 20 to the reading engine 22. After successfully scanning the card 10, the reader 14 can then go into a low power mode.

The reader 14 is linked to either a personal computer or television receiver. This connection can be made via a RS232 serial port or USB present in each of the units, by Bluetooth technology, infrared and the like.

Physically, the reader 14 preferably has an unobtrusive profile, smooth features and no sharp or jagged edges so as to be suitable as a child's toy. In the embodiment shown, the reader is round when viewed in plan and of a size that it can rest easily in the palm of a hand.

The reader 14 is preferably formed ABS plastics or similar material and may be provided with visual features on its outer shell which are themed to different topics associated with the cards 10.

FIGS. 5 and 6 show an embodiment of internal componentry for the reader or scanner. This embodiment of scanner 100 includes a laser source and electronics module 120 of substantially conventional format and a mirror assembly 140 located within the casing 160 of the scanner 100. The mirror assembly 140 includes first and second mirrors 180, 200 which reflect the laser beam 220 from the laser source 120 in the manner shown such that the beam is reflected in two stages to be eventually turned by substantially 180° .

The scanner 100 is provided with a first scanning window 240 at an exterior wall of the casing 160 which allows the laser beam 220 to pass out of the scanner 100 so as to scan a bar code in an item exterior to the scanner 100. A second scanning window is located at a position 260 within the scanner 100 and adjacent a slot 280. The slot 280 allows for media carrying a bar code, such as a card or the like, to be inserted in the bar code scanner 100 for scanning purposes.

The scanner 100 is provided with actuating buttons on the casing 160 and in the preferred embodiment is provided with a button or other sensor within the slot 280 such that scanning is carried out automatically when a card or the like is inserted into the slot 280.

Although the scanner 100 is shown to have a substantially rectangular shape, this is simply for the purposes of illustration. The scanner 100 could have an external shape as to that shown in FIG. 2 or any other desired shape.

Once the reader 14 or scanner 100 (hereinafter simply referred to as reader 14 ) has scanned the barcode 12, the code is sent to the user's computer or television set, from which the appropriate response is incurred, described below. In one embodiment described below, the first response is to find the target site address, which is programmed into the Stand alone PC application. This target site is the host site, for example a website, at which further processing of the card details and provision for interactive use is made. Upon locating the target site, the card identity is verified to an active card list, and then the site system takes over to gain the undivided attention of the user.

The reader 14 is preferably set up only to scan other barcodes when it is disconnected from a computer or television. In one embodiment, if a commercial barcode is scanned while the reader 14 is connected to a computer or television, the user is taken to the site's website to be given the option of direct access to the manufacturer or seller of the item relating to the scanned barcode.

The reader 14 may vary to that shown in FIGS. 2 to 6 in order to position the scanning engine further back from the front face of the reader 14. It may also be provided with a docking station (not shown) from which it can be removed for scanning of commercial barcodes.

The software provided for operating the reader 14, the authorisation routine and the facilities usable with the card 10 can include one or more of the following three major components: 1) a stand alone personal computer based program, 2) a server based Internet program, and 3) a television set (set top box) program.

The stand alone personal computer based program, which will typically be provided on a disc or downloaded from a host site, provides the controls for the reader 14 and data outputs. Upon positive recognition of any barcode while the reader 14 is coupled to a personal computer, this program will automatically start the default browser, dial-up networking and go straight to the host site for authentication. The program will include current versions of all applicable plug-ins that will be needed for the website.

More specifically, once the system's software has been installed in the user's computer and the reader 14 connected, the system is ready to use. By placing a card 10 in the reader 14 triggering the micro-switch 18, the reader engine 22 is activated and begins scanning for a barcode. Scanning will continue for five seconds in total or until a barcode is successfully scanned before this time limit. After scanning, successfully, the reader 14 sends a computer string which contains a barcode string and the scanner MAC address. If the scan is unsuccessful no data will be transmitted to the computer.

From this moment the system Manager Program, described in more detail below, accesses the default browser and goes directly to the website of the host site and transmits the barcode string and MAC address. The host site then verifies the string and either allows or denies access to the user. The function of verification could occur unseen, as just a vector site, or it could be used to buy time for the loading of web-based data by providing a display for a defined period while the site downloads into the user's computer cache. The barcode does not contain any URL information, this data is embedded in the Manager Program and on the database.

Upon positive verification the user may then see the following, using Football as an example:
1) a shock wave video begins to play to introduce the player, the user is preferably not given the option to skip this;
2) a component of the video is advertising, which may highlight what sponsors or equipment the player might have or uses;
c) after the video a generic screen appears that will include the following options:
   download the video or screen saver,
   scan the card to see if you have won anything or
   buy online with a discount.

During all these events targeted advertising is provided which is dynamic and applicable to the card topic. There is also provided an option to download a card image, and other associated information related to the card, to include in the user's card file.

The user will not be able to access any other data or functions while in the host site, apart form the areas that each individual card 10 allows.

Advantageously, the program itself is designed to run in a manner that replicates television, from the view that there is to be minimal “loading”, interesting visuals, mentally stimulating content and as simplistic an operational format as possible. It is not the intention to have numerous menus and options, just clear concise output as explained below.

FIG. 5 shows an example of the video which may be presented at this stage of the connection. The total running time of the preferred video is 30 seconds. The authorisation routine is a four second component that is common in content to all video output. It is to represent the process of the scanned card 10 being verified for authenticity.

The advertising routine is a four second component that is specific to the content of the card 10 scanned, for example if the topic is a football club or player the advertising could relate to equipment suppliers.

The main video content is a sixteen second component of the video, which is specific to the topic of the card 10 installed.

The competition routine is a six second component that represents the installed card 10 being assessed to see if the owner is eligible for a gratuity or prize.

The server based Internet program is intended to perform the majority of the work, by storing the data to be accessed by each individual card 10. It provides the routing to other sites, authentication of cards 10 and supply of other regular facilities of an interactive website, such as chat rooms, billboards, competition areas and so on.

Any suitable programming language can be used, such as Java. This feature need not be Internet based as the video feature could be prestored in the user's computer or provided on a storage medium.

The Manager Program is the user's interface to the system. It preferably operates as a stand-alone item of software while the user's computer is not connected to the Internet, and also as an interactive medium for the full benefits of the system. The system preferably has a specific layout of information and screen views to assist in navigation through the various options provided.

The Manager Program also controls the reader 14.

Examples of applications are now described. These examples use existing technology of barcodes and barcode scanners together with a conventional PC, satellite or cable television or games console, such as the Play Station 2(™) or the Xbox(™), to create an interactive experience. The main functionality of the described examples is to use the information held within each barcode as a key to unlock stored data. This locked data can be of any type of format from simple text, to images, audio, video or even a new piece of programming code to be used by the program itself. Within the system there is also provided a security routine that is central to validating all transactions to ensure that the system cannot be used without correct authorisation.

One application that would lend itself perfectly to this type of functionality is with trading cards, which could be in any form.

The system can bring new features to the conventional trading card principle while giving business an excellent platform for advertising and product development. One target market is 8-14 year olds who represent a major part of the retail market. In addition to the primary function the system preferably also has the facility to utilise the latest technology in on-line shopping and function over the Internet and satellite/cable TV networks.

By placing a barcode on the face of a trading card it can be given a digital identity. When scanned by the appropriate reader the card then becomes a key to what could be considered a digital lock While the user is on-line they will be subjected to specific advertising campaigns as they are accessing the “exclusive” facilities that the specific card installed in the reader will allow.

The reader 14 can also serve as a medium for on-line shopping. Its functionality can include the provision to scan commercial barcodes, which are now present on almost every retail product. This data can then be used online to facilitate e-commerce at the consumer level. The idea is to bring the checkout scanner in the supermarket into the home.

There are several major components that go to making up the system of the examples described below. These are:
(i) barcodes;
(ii) a barcode scanning device;
(iii) a client program for the control of the barcode scanning device that is installed and running in a control computer or satellite or cable television box;
(iv) a control computer, satellite or cable television box or games console;
(v) stored data for the client program to access. This can either be stored locally on the same machine or remotely in a server for access over a network connection such as the Internet.

The basic functionality if the preferred system is as follows. Barcodes are publicly distributed, for free or at a price, each individual barcode can have a single specific code or many of the same code reproduced. These barcodes are related to a specific topic. Each barcode is related to a specific topic and its functionality can be known or unknown by the bearer prior to scanning depending upon the application.

The scanner 14 is used to scan these barcodes. This device is attached to a control computer, satellite or cable television box or games console which has the system's client program installed and running.

Upon scanning, the barcode is transmitted to the client program where it is decoded and authorised. The authorisation can occur locally or remotely via a network or Internet connection.

Once decoded and authorised the function of the barcode is initiated, this function also can be stored remotely or locally, but can only be accessed when the appropriate barcode is scanned.

Added Value Functionality

The basic functionality allows us to use the barcode in many different ways, but one specific area in which the system is able to operate is to add value to the barcode itself and not just provide functionality from the use of the barcodes. This could be done in the preferred embodiment by one of two methods:
a) at the time of scanning the user does not know that there is a redeemable value attached to the barcode and the process of scanning and authorising validates the card so that the bearer is able to claim the appropriate goods or service;
b) the barcode is given a defined value which allows the user to redeem the value of the card via the use of the system.

The first function (a) allows us to use the system as a method of either gratuity, repaying patronage or as a general competition where the bearer of the barcode scans the card to enter and see if the barcode contains a winning sequence of digits. This would be especially good as a means of advertising by being able to promote a product or service, and would facilitate enticing customers into a specific stores or retail outlets.

This is illustrated in a step-by-step format below:
1. The bearer scans a barcode with the reader 14 that is connected to a control computer, satellite or cable television box or games console. Once the barcode has been decoded and authorised it is found that the barcode is a winning code and the bearer is notified of where he/she can redeem the gratuity. This information can be stored locally or sent via a network or Internet connection;
2. The retail outlet is notified of the barcode being valid
   2.1 In the situation where the validation occurs over a server over a network or Internet connection, the target retail outlet is sent an update to its in store sales database to identify the new barcode and the related gratuity. This prevents any person from identifying a winning barcode at the point of sale before being scanned and validated via the network or Internet connection. The barcode must be of a type that can be read by the specific barcode scanner intended in the outlet.
   2.2 However it may not be necessary to access this information over a network or Internet connection, as the data may be stored locally. This would mean that there would be no update to the outlets database, as this information would have already been entered prior to the distribution of the barcode.
3. The barcode is then presented for scanning at the appropriate retail outlet and is scanned on the normal sales barcode scanner. With the outlet database updated, the bearer is now able to redeem the gratuity. The gratuity could be anything such as a discount, free products, free services and so on. This would be exactly the same as scanning a regular commercial product and having the product description appear on the scanning terminal.
4. The token is accepted and the owner is rewarded with the gratuity. At this point the outlet database finishes to transaction by marking the barcode as received and the specific barcode token can be marked as void or offer another gratuity if re-validated via the system. As an example of this the bearer may be initially rewarded with a free product, but upon redemption and re-validation the bearer may receive a discount off the next purchase in that particular store.

The second function enables the system to validate a credit that will allow the user to use that credit value on specific sites that allow this type of transaction. This application could include online gaming where the user does not want to use a credit card to place real money bets. The scanner will improve data entry for the user and act as a method of personal identification for the system. A suitable routine is as follows:
1. The barcode is purchased for a given value, and represents that value in credit.
2. The barcode is then scanned by a barcode scanner that is connected to a control computer, satellite or cable television box or games console. The barcode is then decoded and authorised by a server over a network or Internet connection.
3. The bearer is then able to use the credit for goods or services to the value of the initial cost.
4. At the point where no credit remains the barcode is marked as void.
   Example of Integrating the System into a Console Based Game

The games console market which includes systems such as the Xbox(™), Playstation 2(™) and Game Cube(™). Within this market there is a high demand for “Cheat Codes”. These are codes that allow the player to cheat various sections of the game. This could be in the form of unlimited life, unlimited ammunition or even access to hidden levels. One more subtle function of cheat codes is to prolong interest in the games, increasing the length of their popularity and extending their commercial life.

These “Cheat Codes” are currently inputted manually, a process which is very time consuming and frustrating. This process could be made much easier if the user could scan a cheat barcode.

The following would illustrate a suitable routine:
1. A “cheat” barcode is scanned with a reader 14 attached to a control games console which has the client program installed and running as a component of a game.
2. On scanning, the cheat barcode is transmitted to the client program where it is decoded and authorised. The authorisation can occur locally or remotely via a network or Internet connection.
3. Once decoded and authorised, the function of the cheat barcode is initiated. This function also can be stored remotely or locally, but can only be accessed when the appropriate barcode is scanned.

In the example where decoding and authorisation is carried out remotely, it is possible to modify the functionality of specific codes, as their function could be changed at any time. An example of this is to give the code a finite life.

FIGS. 8 to 18 show an embodiment of display arrangement, in the form of screen views or shots. The screen shots are intended to provide a more user friendly and simpler user interface that current interfaces. For example, it is not necessary to have the conventional “File, Edit, View, Insert” menu layout. The preferred layout can be seen in FIG. 8.

As the Manager Program is specifically designed to work interactively over the Internet, it is useful to optimise the visual performance of the software. The key objective to be considered when developing the program is speed of operation.

The described embodiment can provide minimal “loading” whilst on line and backgrounds of target websites and other constant visuals and hyperlinks are stored onto the user's computer to reduce accessing times (cache).

Using the system of this embodiment is preferably analogous to watching television, that is without any waiting with a blank screen while the site is being downloaded.

Following initiation of the Manager Program, the user is presented with a control “ball” 30 which provides access to various icons 32, in which each menu and its sub-directories appear in ascending order from the opening screen shot. The look of the control panel is not limited to this style, the user may be able to apply different “skins” to change the look of the control panel.

To access the sub-directories or functions under a 1^{st} Level menu, instead of the usual drop down windows, the icons 32 on the control ball 30 change to suit the new options. In addition to this when the cursor hovers over any one of the icons the function key word 31 is displayed in the centre of the control ball 30.

The Main Menu return icon 34 can be activated, in usual manner, to return to user to the main menu within the Manager Program. This feature is to be animated so that when the user hovers over the icon 34 the function keyword 31 changes to “Main Menu”. Also when the icon 34 is selected it is visually depressed down to become the same profile as the ball exterior 30.

During loading the “loading bar” 36 is activated with the slats of the bar becoming illuminated in an up and down oscillating manner, until loading is complete whereupon the indicator 36 will then remain static.

When a menu is selected and the sub-directories are to follow, the replacement of the icons 38 to suit the sub-directories occurs with a small amount of animation, as will be apparent from FIG. 11.

A list of the icons 38 for the described embodiment are shown in FIG. 10. These icons 38 are used both in the Manager Program and also by the host site.

The preferred icon location on the control ball 30 is denoted by the following code:

| Icon Name | Position |
|---|---|
| Demo | 2 |

The position number can be seen on the control ball of FIG. 9. These positions will have defined co-ordinates, when referenced to the master bitmap, within the individual menus are as shown in FIG. 12.

The co-ordinates for the loading bar 36, menu return 34 and key word 31, with reference to the master bitmap are as shown in FIG. 14.

For example, if the Manager Program is opened via a short cut and there has been no card scanned, the menus, sub-directories and on screen image would be as shown in FIG. 15.

The nature of the menus in the preferred embodiment is as follows.
Scan: This advises the user to insert a card 10 into the reader 14. Upon this command the Scan prompt also checks to see if there is a working reader 14 attached, which is also a component of this screen. If no scanner is detected a warning is displayed.
View Image: This prompts the user to select a saved card image to view. Each card file is identified by its image content and the file name is automatically set from the website.

Sub-directories:
Flip Card: During narrow screen mode only one side of the card can be viewed, you cannot view the card in wide screen. This function allows the user to see the other side of the card
View Info: Shows the factual information relating to the card in wide screen mode
Play Video: Plays the video related to the selected card, which has been downloaded
View Image: Shows the high resolution image related to the card that has been downloaded
Print: Prints out a one page information sheet featuring the card faces and factual information relating to the specific card
Main Menu: Returns the user to the main menu
Tools: This menu contains all of the user adjustable settings under two main headings, Scanner and Internet.

Sub-directories:
Scanner: This brings up a new window, which contains all of the settings and adjustments that the user can alter. It also features a scanner communication check.
Internet: This menu brings up the normal Internet Setting window.
PC Set-up: This brings up a new window, which lists the settings for the screen and a button to access the printer settings
Main Menu: Returns the user to the main menu
Help: All Help type information

Sub-directories:
System Help: This opens a new window, which contains a help file starting on the contents page
Read Me: Opens the read me file on the note pad
Contacts: Has the company contact information, this information is to appear on the viewer and not in a new window
About: Lists the software version and licensing information. It is to appear on the Viewer and not in a new window
Main Menu: Returns the user to the main menu

When a card is scanned with the Manager Program it opens the system and connects to the Internet. The icons 38 viewed at this point are the same as if the program is started manually through a short cut. When the card is authorised, the menus that are on the control ball 30 change to suit the on-line functions. The menu would appear as listed in FIG. 16. This menu would also appear if a card 10 were scanned with the Manager Program started. It should be noted that the first thing to be displayed after connecting to the Internet and authorisation is to play the flash video relating to the card 10. At this point and the user will not be able to do anything, except shut down the program, until this has finished. This is primarily for advertising purposes.

Menu Descriptions
Flip Card: During narrow screen mode only one side of the card can be viewed, you cannot view the card in wide screen. This function allows the user to see the other side of the card
View Info: Shows the factual information relating to the card in wide screen mode
Replay Video: Replays the video presentation
View Image: Opens the high-resolution image relating to the card in the default graphics viewer installed onto the host PC
Download: This downloads all of the files associated to the card

There is also another function that the Manager Program carries out even if the program has not been started. A small component of the Manager Program is installed into the start-up file and it is this program that monitors the reader 14. This program constantly queries the serial port for the presence of the reader 14. If this query comes back positive, then the program then goes into a dormant state awaiting an output string from the reader 14.

If a card 10 is installed into the reader 14 at this point, the Manager Program will automatically run the default dial up networking connection to access the host website. If the reader 14 has successfully scanned the card 10, the string would be transmitted to the site as soon as it has successfully logged on. To improve the output in this situation the Manager Program would also cache the most popular system topic being accessed by that reader 14, and in the instance of a non-successful scan this would be transmitted to our website where it is used to alter the visuals to suit.

If the barcode has been successfully scanned and transmitted the card 10 would then go on to the verification stage, explained in detail below.

If at any time a new card 10 is scanned the Manager Program will halt what it is doing and initiate the input of the new barcode string.

The full functions of the Manager Program are realised when it is logged on to the host website. If a card 10 is scanned the next step is verification. If the card 10 passes verification then the user is enabled to access restricted areas of a topic within the host website.

The Manager Program allows the printing of data.

The preferred authorisation routine seeks to provide a reasonable level of security and to seek to prevent counterfeiting of cards and other fraud. For this purpose, the numbering of each individual card 10 of the same design may be sequential or random. As each card will be an individual entity identifiable by a unique barcode printed on the card 10, if a single barcode is identified as being read in either an impossible situation (for example by being read by more than one reader at one time), or a large number of times over a short period of time, plus geographical considerations, then the card will be disabled at the host site.

The preferred disabling procedure could be considered analogous to changing a lock to “disable” a particular key. Although the card will still exist and preferably also retain some of its uses, it will be disabled for any uses which have value to the system. Valued uses may include its status as a winning card for a competition, its status in a particular interactive game and so on. The card may nevertheless remain enabled for other uses, such as providing a general discount at a particular shop and for downloading some data relating to the card.

In the preferred implementation, the system provides for the issue of a warning of a disabled card 10.

This type of security would achieve several objectives. Apart from directly controlling the legal access to the host service, it would also highlight areas of counterfeit distribution. Moreover, since security is of paramount importance in the current open access environment of the Internet, the system preferably ensures that there are distributed, such as on cards 10 and the like, no internal master codes which will allow unrestricted access to the target sites from an external location.

When the Manager Program the host site for verification it does not immediately access the home page but a verification page. The home page is to promote the system itself and provide support to users.

The website is the centre of the system, as it contains all links, card associated files and security protocols associated with the system. The first operation when a barcode string has been transmitted is verification. The card string is logged and then checked to an active card register. As each of the cards 10 has its own identity the website can easily monitor each card individually for usage.

The following is a list of events which would be deemed to show under which circumstances a card would fail verification:
a) if a single string is accessed more that once at the same time
b) if a single string is accessed by multiple MAC addresses over a defined period, e.g. 240+times in 24 hours
c) if the string has already been identified of not passing validation

The criteria for authorisation can be seen below.

The inputting of the string would be an automatic operation and there is to be no provision of manually typing in the string, which assists in the security of the site. During the verification stage the reader 14 MAC address is also transmitted. Without this piece of data the verification would also fail.

The host website home page preferably uses visuals and has menu operation which is the same as the Manager Program. They will all appear on a control ball in ascending order from the main page. The first function that is carried out when a user logs-on to the website is a fast flash movie like a quick 10 second advert, after which the main page appears which would look somewhat like this image of FIG. 17.

The basic requirement for this component is to promote the system. There is no need for a complex site with many sub-directories. The information is preferably concise and laid out in a manner that is easily digestible. The major promotional content is in the form of a video presentation. In addition to this there are preferably other facilities such as online purchasing, demonstrations, help information and e-mail facilities.

Each menu and respective sub-directory has its own individual icon 38 which appears on the control ball 30 at the appropriate stage, as in the Manager Program. In addition to this the function keyword operation 31 is also the same as the Manager Program.

The main menu and sub-directories are preferably as shown in FIG. 18.

The menu descriptions for the menus shown are as follows.
Demo: By selecting this menu the user is shown a flash type presentation, which explains the system and how it operates. This is to play automatically after pressing Demo.

Sub-directories:
Play: Plays the presentation
Home: Returns the user to the Home Page
Buy: This function allows the use to purchase a Blinx Scanner or Cards

Sub-directories:
Online: Takes the user to a secure online purchasing area within the website. For the purposes of the demo this function will be displayed by opening a browser window, which will contain an order form.
In-Store: Offers the user retail outlets where they can but a Blinx Scanner and Card Sets. This information is presented but location. To illustrate this a new window will be opened that contains a form.
Home: Returns the user to the Home Page
Help: This menu allows the user to access help information for the set-up of their reader

Sub-directories:
Computer Set-up: Advises the user on how to install and set-up the software and Internet settings
Scanner: Advises the user on how to install and set-up the reader 14, including battery installation
Contact: This sub-directory lists the contact information for service provider
Home: Returns the user to the Home Page
E-Mail: Opens up an e-mail page to Blinx with the appropriate address in the correct field.

The main menu return 34 also functions as a direct link to the home page and, like all other icons 34, when the user hovers over the menu return icon, the function keyword 31 changes to “home”.

FIG. 18 shows a flow chart of the preferred embodiment of validation routine performed by a shop/store when a user presents a card 10 for collection of a prize or other promotional facility such as a discount. The process through this flow chart will be immediately apparent to the reader from reviewing the chart.

Operational Routine

Manager Program

1. Install software, during the installation the user is prompted to connect the reader 14 into the RS232 port. An icon for the Manager Program is placed on the desktop and mini icon appears in the bottom right hand corner of the toolbar, a version of the preferred browser program is also installed on to the host PC which configures itself to the default dial up connection (go to 2).

2. The software then polls the RS232 port at a timed interval for the reader 14. If there is a reader 14 present then go to 4, if there is no reader present then go to 3.

3. The software registers that there is no reader present, the Manager Program then alters the mini icon 38 to show that the system will not function. This can be represented by a red circle with a white cross in the middle of it appearing over the mini icon 38. If the Manager Program is started via the “programs” menu, or by double clicking the desktop icon, a warning will appear on the screen after the program introduction to advise that the reader 14 is not connected. The Manager Program continues to poll the RS232 port, and the warning then prompts the user to continue without the reader 14 present (go to 10).

4. The software registers that there is a reader 14 present in the RS232 port then the mini icon 38 remains unchanged (go to 5).

5. The user can then do one of three options, insert a card 10 into the reader 14 (go to 6), start the XSCW major program via the “programs” menu, and also by double clicking the desktop icon (go to 7), or the user can activate the scanner 14 and read a commercial barcode by pressing the activate button on the reader (go to 22).

6. A card 10 is inserted into the reader 14, which activates the scanning engine 22 for a defined period. If the reader 14 successfully scans a barcode then go to 8, if the reader unsuccessfully scans a barcode then go to 9.

7. The Manager Program starts and prompts the user to either insert a card 10 into the reader (go to 6) or connect to the Internet (go to 21) or open an existing card file (go to 18).

8. The barcode and reader MAC address is then transmitted to the Manager Program, which then starts the major program up if it is not already started. The Manager Program then checks to see if the user's computer is connected to the Internet. If it is connected then go to 11, if it is not connected then go to 12.

9. The Manager Program is initiated and does not start the dial up Internet connection. The Manager Program advises the user that the scan was not successfiil and prompts them to either insert the card 10 again (go to 6), scan the barcode again (go to 22) or open an existing card file (go to 18).

10. The Manager Program prompts the user to either start the reader connection instructions (go to 20) or open an existing card file (go to 18).

11. The Manager Program then accesses the host website and transmits the barcode and unit MAC address. The barcode is identified as either of known series or as a commercial type by the software. If it is a known barcode, the user is greeted with visuals and audio associated with the card series, and along with a message that advises the user that the card is being checked for authenticity. If the card 10 passes authenticity then go to

13, if the card 10 fails authenticity then go to 14. If the barcode is a commercial type then go to 23.

12. The Manager Program then starts the default dial up connection. If this connection attempt is successful then go to 11, if the connection is unsuccessful then go to 15.

13. The barcode is then used as part of the URL to access information on the host website directly related to the individual card. An image of both sides of the card is automatically sent to the user's computer and can then be stored into a specific folder saved by the Manager Program. The file saving process is supplied by the website and saves each individual card image into the correct file. This card image and file can be accessed by the Manager Program off-line (go to 16).

14. The user is advised that the card 10 has not passed authenticity and after a defined period is vectored to the host site home page.

15. A message is returned that the dial up connection has failed and the computer then retries to connect. If this connection attempt is successful then go to 11, if the connection is still unsuccessful then go to 17.

16. The W/S automatically places the card image into the correct file. This file can be accessed whilst off-line through the open card file menu.

17. The XSCMP advises the user that connection was unsuccessful and prompts the user to either look at his card files off-line (go to 18) or start the dial up connection trouble-shooting guide (go to 19).

18. The Manager Program displays the open file menu.

19. The dial up connection trouble-shooting guide menu is automatically opened.

20. The Manager Program displays the reader connection instructions.

21. The Manager Program accesses the host website and goes to its home page.

22. The reader 14 has been activated to read a commercial barcode. If the scan is successful then go to 8, if no then go to 9.

23. The commercial barcode string is vectored to another part of the host website, where it is submitted into a barcode search engine.

Authorisation Routine

During remote authorisation several variables are used to determine the fraudulent usage of the system. These variables are the barcode itself, the user identification number the IP address relating to the network or Internet connection and an access number which is the total allowable number of times that a single barcode can be accessed within a defined period of time, for example 10 times per hour. This authorisation routine is a function carried out by the server to determine the correct usage criteria for each individual barcode.

1. The barcode string, User ID, IP and time of input is entered for authorisation, all values are then recorded to a card access file. If it is the first time that the barcode has been entered, then go to 2, if is not the first time that the barcode has been entered then go to 4.

2. Is the barcode string and User ID listed on the database (i.e. Approved for use), if yes then go to 3, if no then go to 7.

3. Modify the entry in the card access file to identify the first usage of the card and that the combination of barcode, User ID and IP has been authorised, go to 6.

4. Is the barcode string and User ID listed on the database (i.e. Approved for use), if yes then go to 5, if no then go to 7.

5. Assign a number to the record in the card access file that represents the number of times that the barcode has been entered. Is the barcode, User ID or IP address on the restricted list? If yes then go to 7, if no then go to 8.

6. Allow access to restricted data files and modify the card file record to show that the combination of barcode and User ID has been authorised.

7. Authorisation failed

8. What security level does the barcode string posses, if security level I then (go to 9) if security level 2 then (go to 12)

9. Is the barcode data being accessed (with an IP address already approved) by more than one IP address at this moment in time, if yes then go to 7, if no then go to 10.

10. Has the number of times that the barcode been accessed with a different User ID or IP address exceeded the access number listed for that barcode? If yes the go to 7, if no then go to 11.

11. Has the Barcode and User ID combination been approved before? If yes then go to 12, if no then go to 6.

12. Has the number of times that the same Barcode and User ID been accessed by a different IP address exceeded the access number listed for that barcode? If yes then go to 7, if no then go to 6.

Connection Routine

This component of the system is a step-by-step guide to display on screen the correct method by which to install the reader 14. Each step is displayed in a small central window, like that used in many install programs with control buttons located in the bottom right hand corner.

Step 1

Introduction to the Reader Connection Wizard
Control Buttons: Next, Cancel
   Step 2
Battery Installation and power check by pressing the operate button to activate the scan engine.
Control Buttons: Back, Next, Cancel
   Step 3
Cable connection to the reader and the serial port
Control Buttons: Back, Next, Cancel
   Step 4
Communication check
Control Buttons: Check Communication, Restart Connection Wizard, Back, Next, Cancel
   If the “Check Communication” control button is selected then the Wizard will follow the go to list below:
   1. The Manager Program polls the serial port for the presence of the reader. If the reader 14 is present then go to 2, if the reader is not present then go to 3.
   2. Display a Communication OK window and continue to step 5.
   3. Display a Communication Check Failed window, and prompt the user to either restart the connection wizard (go to step 1), check the communication again (go to step 4), go online to the Help site (go to step 4) or to cancel the communications check (go to step 5).
   4. Open the browser, start the dial up networking and access the host website.
   5. Cancel the Wizard.
      Step 5
Connection Wizard closing page
Control Buttons: Back, Finish

1. A trading or playing card system including on at least some of a plurality of trading or playing cards a code providing a gaming advantage usable in an electronic game to adjust electronically the playing characteristics of the game to the advantage of the user.

2. A system according to claim 1, wherein the code allows for the cheating in one or more section of a game.

3. A system according to claim 1, wherein the remote site is accessed by the Internet or television.

4. A system according to claim 1, wherein the system provides for the display of advertising linked to the card or cards identified by the system.

5. A system according to claim 1, wherein the cards or other media have specified identities or characteristics, said identities or characteristics providing an embedded value determinable by validation by a third party.

6. A system according to claim 5, wherein the specified identities or characteristics includes a monetary characteristic.

7. A system according to claim 6, wherein said monetary characteristic includes a discount on goods or services, free goods or services, or money or money's worth.

8. A trading or playing cards system comprising a plurality of cards having specified identities or characteristics, and a remote site providing interactive applications controlled by the identities or characteristics of the cards.

9. A system according to claim 8, wherein the interactive applications include interactive games.

10. A system according to claim 8, wherein a card includes predetermined characteristics affecting the degree of control of the game.

11. A system according to claim 8, wherein the cards are provided with machine readable codes indicative of said identities or characteristics.

12. A system according to claim 8, wherein the remote site is accessed by the Internet or television.

13. A system according to claim 8, wherein the system provides for the display of advertising linked to the card or cards identified by the system.

14. A system according to claim 8, wherein said identities or characteristics provide an embedded value determinable by validation by a third party.

15. A system according to claim 14, wherein the specified identities or characteristics includes a monetary characteristic.

16. A system according to claim 15, wherein said monetary characteristic includes a discount on goods or services, free goods or services, or money or money's worth.

17. A system according to claim 2, wherein the remote site is accessed by the Internet or television.

18. A system according to claim 2, wherein the system provides for the display of advertising linked to the card or cards identified by the system.

19. A system according to claim 3, wherein the system provides for the display of advertising linked to the card or cards identified by the system.
